(19) United States
(12) Patent Application Publication
(10) Pub. No.: US 2025/0153909 A1
(43) Pub. Date: May 15, 2025

(54) DOUGH PROOFING CONTAINER

(71) Applicant: GOZNEY GROUP LIMITED, Christchurch Dorset (GB)

(72) Inventors: Thomas Robert Llewelyn GOZNEY, Dorset (GB); Ryan BREEZE, Christchurch Dorset (GB)

(21) Appl. No.: 18/835,110

(22) PCT Filed: Feb. 2, 2023
(86) PCT No.: PCT/EP2023/052545

§ 371 Date: Aug. 1, 2024

(30) Foreign Application Priority Data
Feb. 4, 2022 (GB) 2201456.7

(51) Int. Cl. B65D 51/16; A21C 13/00; A21D 8/04; A47J 47/08; B65D 1/34; B65D 21/02; B65D 25/10; B65D 25/16; B65D 43/02; B65D 51/24; B65D 53/02

(52) U.S. Cl. CPC B65D 51/1644; A21C 13/00; A21D 8/04; A47J 47/08; B65D 1/34; B65D 21/0209; B65D 25/10; B65D 25/16; B65D 43/0202; B65D 51/245; B65D 53/02; A47J 2202/00; B65D 2543/00194; B65D 2543/00361; B65D 2543/00972

(57) ABSTRACT

Disclosed is a dough proofing container comprising comprising a receptacle defining a container volume; a resealable lid, the lid being repeatably connectable to the receptacle to close the container volume, the lid comprising a pressure release valve configured to permit gases to escape from the container volume and inhibit gases from entering the container volume; and a thermometer configured to measure and display a temperature of the container.

### CROSS-REFERENCE TO RELATED APPLICATIONS

The present application is a U.S. National Stage filing under 35 U.S.C. 371 (c) of International Application No. PCT/EP2023/052545, filed Feb. 2, 2023, which claims priority to Great Britain Patent Application No. 2201456.7, filed Feb. 4, 2022, the disclosure of which is hereby incorporated by reference in its entirety.

This disclosure relates to a container for dough. More particularly, the disclosure relates to a reusable dough container for proofing dough.

### BACKGROUND

When preparing foodstuffs such as leavened breads or pizza, the dough must be proofed before cooking to achieve a successful final product. Proofing is a common stage of dough preparation in which uncooked dough is allowed to rise for a predetermined time (varying from minutes to hours or days) in carefully controlled conditions to achieve the desired internal structure. Proofing is a crucial stage in dough preparation, and it is important for the process to be controlled precisely to achieve the desired results. However, there are often competing factors and difficulties in achieving and maintaining, the desired conditions for proofing, particularly during longer proofs.

The proofing dough will usually need to be protected from the ambient environment. Ambient air passing over the dough for extended periods of time can dry out the surface of the dough, which can inhibit expansion of the dough and result an inferior final product. A competing factor is the volumetric increase of the dough and gases released by the expanding dough, which can raise the pressure in a sealed container. A significantly increased pressure around the dough is typically undesirable as this can inhibit the dough's expansion.

Although some known containers—for example as disclosed in U.S. Pat. No. 5,547,694A—provide a pressure relief valve, these container introduce their own issues. They can be environmentally unfriendly, may be subject to blockages by expanding dough, may be difficult to effectively clean (which is particular important in commercial settings to meet food safety standards), and may prevent large numbers of containers being closely packed. Further, the available proofing containers may be unsuitable for large proofs, such as for commercial batches of dough, and may not allow users to control or measure the temperature of the proofing container accurately.

It will be understood that the currently available dough proofing containers have various limitations and, therefore, that improvements to dough proofing containers are desirable.

### STATEMENTS OF INVENTION

According to a first aspect, there is provided a dough proofing container in accordance with the appended independent claim 1. The dough proofing container comprises a receptacle defining a container volume and a resealable lid. The lid is repeatably connectable to the receptacle to close the container volume. The lid comprises a pressure release valve configured to permit gases to escape from the container volume and inhibit gases from entering the container volume. The dough proofing container further comprises a thermometer configured to measure and display a temperature of the container.

The lid may be configured to sealingly close the container volume. It should be understood that although the lid seals against the receptacle, fluid communication with the ambient environment may occur via the pressure release valve.

The dough proofing container may further comprise a removable dough-supporting insert configured to be received in the receptacle. The dough-supporting insert may comprise or define a relief for supporting a portion of dough.

The insert may be configured as an open vessel or tray with a single relief, for example having a relief defined within a peripheral wall of the insert. The relief (or reliefs if plural) may be substantially cuboidal, ovoid, or hemispherical.

The insert may comprise a peripheral sealing element which, in use, is located between the lid and the receptacle so as to form a seal or an additional seal between the lid and the receptacle when they are attached together.

The insert may be configured to provide an airgap between a wall of the receptacle and the insert. For example, the insert may comprise a substantially planar surface into which the relief or reliefs are formed, such that an airgap is formed around the underside of the reliefs between the receptacle wall and the planar surface. This may provide improved insulation for the dough to maintain a more consistent temperature.

The insert may be formed from flexible material. For example, the insert may be silicone-based.

The dough proofing container may comprise a plurality of dough-supporting inserts that substantially tesselate within the container volume. For example, a plurality of inserts, of the same or different types, may be installed within the receptacle to proof a plurality of separate dough portions, optionally of different types of dough or differently shaped dough portions.

The receptacle may be substantially rectangular in plan. The dough supporting insert may be substantially rectangular in plan. The insert may have a base surface area substantially equal to one half, one third, one quarter, one fifth, one sixth, one eighth or one tenth of a base surface area of the receptacle, such that a plurality of inserts may be located within the receptacle to substantially cover the entire base surface area of the receptacle.

The dough-supporting insert may comprise or define a plurality of reliefs. Each relief may be for supporting a separate portion of dough. For example, a single insert may comprise two, three, four, five, six, eight, or ten reliefs. The plurality reliefs may be substantially equally spaced apart or distributed across the insert. The insert may have or define a plurality of identically shaped reliefs. It should be understood that the reliefs may be configured to each receive an individual portion of dough and to separate the dough portion from other dough portions within the receptacle.

The insert could, for example, define one or more upstanding walls which are open at the bottom, such that dough received in the relief is in contact with the bottom surface of the receptacle, but separated from adjacent dough portions by the upstanding wall or walls.

The dough-supporting insert has a height of less than an internal height of the receptacle volume so as to provide an airgap between the insert and the lid. This enables all dough portions within the container volume to be in communication with the pressure release valve on the lid and provides an insulating gap between the dough and the lid.

The dough proofing container may comprise a removable liner shaped to be received in one of the plurality of reliefs, optionally comprising a plurality of removable liners. The removable liner may be shaped to conform to the relief or reliefs. This may enable easy removal and handling of dough portions without the requirement to remove the insert, which may still contain other dough portions.

The liner may be formed of a flexible material. The liner may be at least partially formed from silicone. The liner may be a different colour and/or texture to the insert.

The or each removable liner may comprise a gripping portion which protrudes above the dough-supporting insert when the liner is received in the relief.

The resealable lid is constructed from a substantially transparent material or comprises a substantially transparent portion. This may enable observation of the dough without opening the container volume and reading of the thermometer without removal of the lid from the receptacle. In some examples, the substantially transparent material may be partially transparent or tinted.

A readable display of the thermometer may be positioned so as to be visible though the resealable lid. The lid may comprise the thermometer. The thermometer, or a portion thereof, may positioned on or affixed to a receptacle-facing side (i.e., inner surface) of the lid so as to measure the temperature within the container volume when the lid is connected to the receptacle. The thermometer comprises thermochromic material. In some examples, the thermometer may be a thermochromic thermometer fixed to the underside of the lid and have a readable display surface affixed against the underside of a transparent portion of the lid, such that the internal temperature of the container volume is readable through the lid.

The dough proofing container may comprise a removable sealing element configured to form a seal between the lid and the receptacle. The sealing element may be configured to be attachable to the lid and/or the receptacle. The removable scaling element may be a gasket, such as a rubberised or silicone gasket.

The pressure release valve may be removable. The pressure release valve may be an umbrella valve. A valve element of the umbrella valve may be removable. The pressure release valve may be a one-piece valve, such as a duckbill valve.

The pressure release valve and/or the thermometer may be positioned substantially centrally on the lid. In other words, the pressure release valve and/or thermometer may be positioned proximate the centre of the lid's surface. Positioning the valve centrally may provide improved degassing for large or plural dough portions.

The lid may comprise a stacking feature shaped to conform to an external shape of a base of the receptacle. In some examples, the surface area of the base of the receptacle may be smaller than the surface area of the lid. The stacking feature may be a recess shaped to conform to the exterior shape of the base of the receptacle.

The container may comprise a spacing feature configured to provide an aspirating airgap between the lid and the receptacle of another dough proofing container stacked upon the lid. The airgap provided by the spacing feature may permit communication of the pressure release valve and the ambient environment.

The spacing feature may be provided on the lid. The spacing feature may be provided on the receptacle, optionally on the base of the receptacle, on an underside thereof. The spacing feature comprise a protruding element for supporting the stacked container. The spacing feature may comprise a recess to provide an airgap. A plurality of spacing features or spacers may be provided. The spacing feature or spacers may be protruding elements which support the stacked container above the lid to provide the stacking airgap.

The receptacle may have an external length (i.e. a longest dimension in plan) of less than or equal to 450 mm. The receptacle may have an external width (i.e., a shortest dimension in plan) of less than or equal to 300 mm. The container (i.e., the lid and receptacle when connected) may have a total external height of less than or equal to 178 mm. The receptacle may have an external height of less than or equal to 80 mm.

According to a second aspect, there is provided a method of using a dough proofing container. The method comprises: placing a dough directly into the receptacle and connecting the lid to the receptacle; bulk proofing the dough for a bulk proofing time; removing the lid from the receptacle; dividing the dough into a plurality of dough portions; placing the insert in the receptacle; placing a dough portion into the relief of the insert; re-connecting the lid to the receptacle, and proofing the dough portion for a second proofing time.

The container can conveniently be used for both stages of a two-stage proof, with a bulk fermentation taking place with the dough received directly in the receptacle, and then portions of the dough being proofed for a second time using the insert in the receptacle.

The skilled reader will understand that the abovementioned features and/or limitations may be combined freely in accordance with keeping this disclosure, except for combinations of such features that are mutually exclusive.

### BRIEF DESCRIPTION OF THE DRAWINGS

Examples will now be described, by way of example, with reference to the accompanying drawings, in which:

FIG. 1 shows a perspective view of an exemplary dough proofing container;

FIG. 2 shows a perspective view of a receptacle of the exemplary dough proofing container of FIG. 1;

FIG. 3 shows an upper perspective view of a lid of the exemplary dough proofing container of FIG. 1;

FIG. 4 shows a lower perspective view of the lid of FIG. 3;

FIG. 5 shows a perspective view of further exemplary dough proofing container comprising a dough-supporting insert;

FIG. 6 shows a plan view of the dough proofing container of FIG. 5;

FIG. 7 shows an exploded view of the dough proofing container of FIG. 5; and

FIGS. 8a-c show an exemplary dough-supporting insert for a dough proofing container;

FIG. 9 shows a partial sectional view of a sealing arrangement of the dough proofing container of FIG. 5;

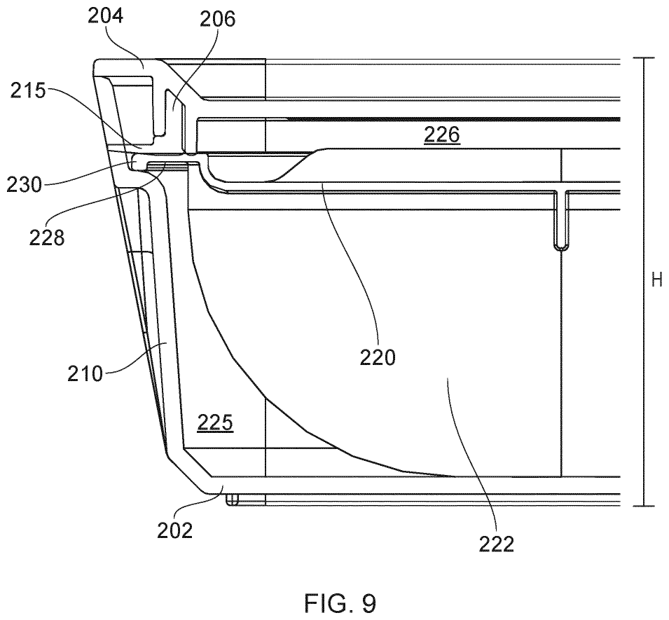

FIGS. 10 and 11 show further exemplary dough-supporting inserts for a dough proofing container;

FIG. 12a shows a detailed plan view of a pressure release valve and thermometer of the dough proofing container of FIG. 5;

FIG. 12b shows a detailed sectional view of the pressure release valve and thermometer of FIG. 12a;

FIG. 13 shows a detailed view of two exemplary dough proofing containers in a stacked configuration; and

FIGS. 14a and 14b show an exemplary liner for a dough-supporting insert.

### DETAILED DESCRIPTION

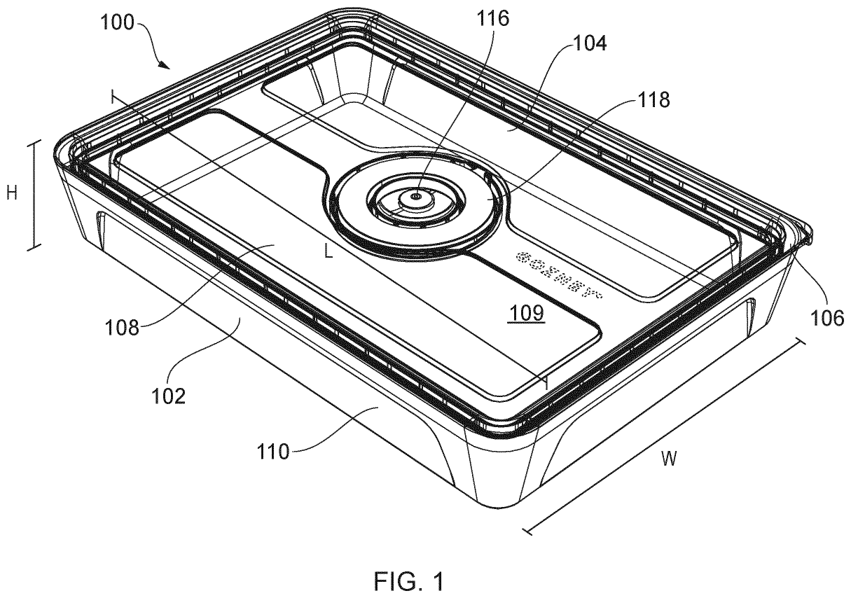

With reference to FIG. 1, an exemplary dough proofing container 100 is shown.

The dough proofing container 100 comprises a receptacle 102 defining a container volume and a resealable lid 104. It should be understood that the container is generally reusable and washable such that it can be used repeatedly over long periods of time, for example in commercial kitchens. The lid 104 can be attached to and released from the receptacle easily and quickly to seal and open the container 100 many times throughout the products life without replacement of any parts. The materials of the lid and receptacle are substantially impermeable to isolate the interior of the container from the ambient environment.

The resealable lid 104 is repeatably connectable to the receptacle 102 to close the container volume in a sealing manner. In this example, the lid 104 comprises a removable sealing element 106 about its periphery which is elastically deformed when the lid is placed onto the receptacle with force. The removable sealing element 106 is configured as a gasket, and in particular as a rubberised or silicone gasket. The sealing element 106 provides an airtight seal between the receptacle 102 and the lid 104 and also causes an interference fit to assist in retaining the lid 104 on the receptacle 102. Although not shown in this example, the lid may also be secured to the receptacle using clips, resiliently deformable tabs, screw threads, or other releasable connectors of the like. In the illustrated examples, the sealing element 106 is configured to be attached to the lid, however, it should be understood that a sealing element may alternatively or additionally be connected to the receptacle. The sealing element 106 is removable from the lid to facilitate effective cleaning.

The receptacle 102—and therefore the container 100—has an external length L (i.e. a longest dimension in plan) of less than or equal to 450 mm and, in this particular example, 437 mm. The receptacle 102—and therefore the container 100—has an external width W (i.e., a shortest dimension in plan) of less than or equal to 300 mm and, in this particular example, 300 mm. The container 100 (i.e., the lid and receptacle when connected) may have a total external height H of less than or equal to 178 mm. The receptacle 102 has an external height of less than or equal to 80 mm. An alternative container that is circular in plan view may have a diameter of less than 300 mm, and a further alternative container which is substantially oval in plan may have a major axis of less than 450 mm and a minor axis of less than 300 mm. Containers having some or all of these dimensions may provide a substantial volume for proofing dough, while also being compact enough to fit conveniently onto the shelf of a standard consumer refrigerator.

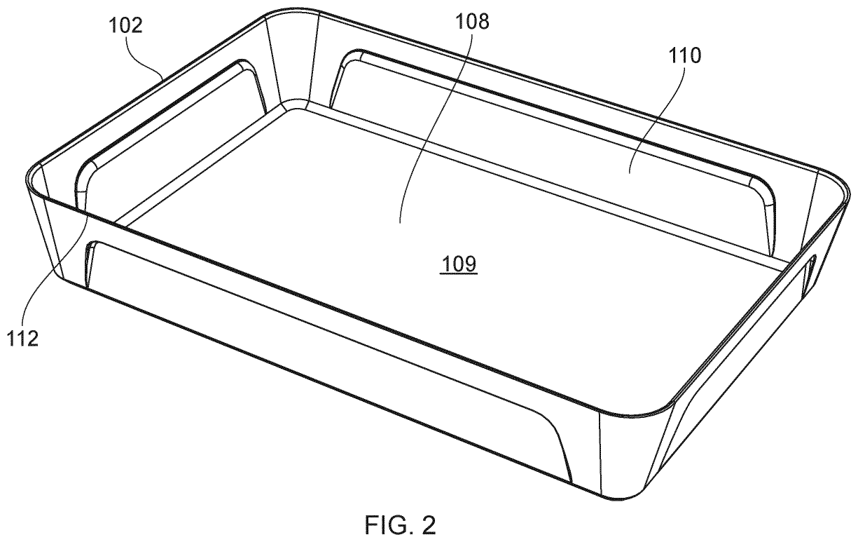

The receptacle 102 is shown in isolation in FIG. 2. The receptacle 102, in this example, is substantially rectangular in plan view and takes the form of a tray having a rectangular bottom surface 108 and an upstanding peripheral wall 110 surrounding the bottom surface 108. The receptacle 102 is substantially hollow and defines the container volume 109, i.e., the internal space of the container in which dough is proofed.

In this example, the peripheral wall 110 is slightly outwardly flared from bottom to top such that the upper opening 112 of the receptacle is slightly larger in area than the bottom surface 108. In this way, a plurality of receptacles 102 can be stacked in a space-saving manner for storage when not in use. Further, in this example, the peripheral wall 110 features indents which provide improved grip for carrying the container. Other receptacle shapes can be envisaged, having generally square bases, generally circular or oval bases, or other polygonal base shapes, and having differing proportions to the exemplary receptacle shown in FIG. 2. A receptacle could equally have a bowl-like or plate-like shape in keeping with the principles of this disclosure. The upper edge of the peripheral wall 110 is configured to be sealed with a lid.

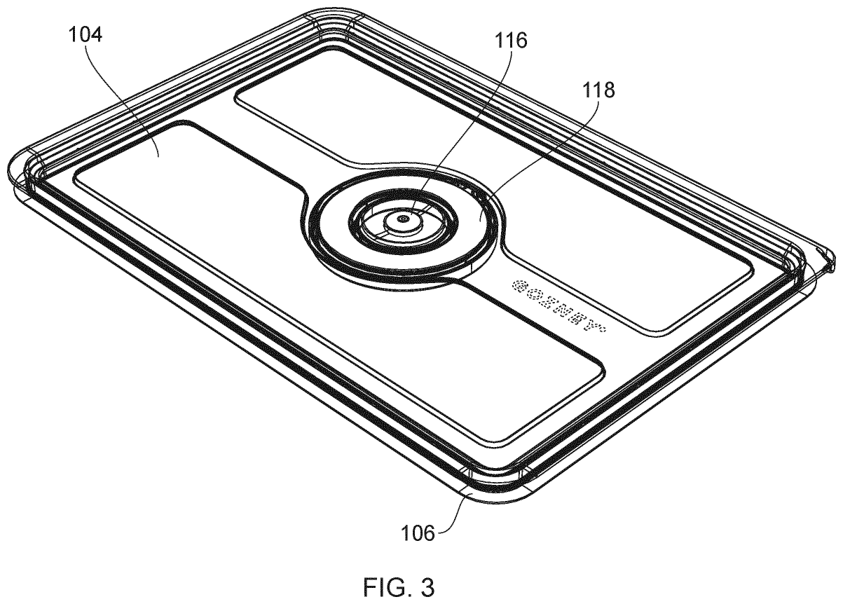

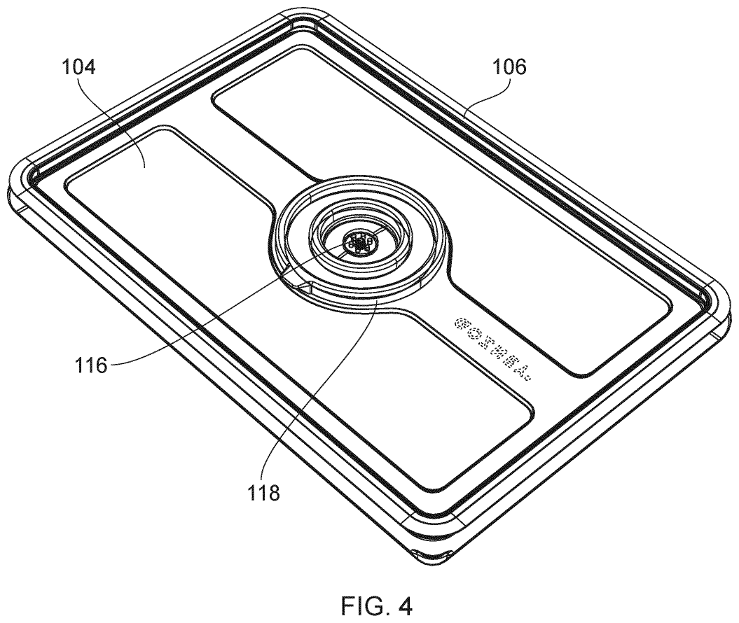

Turning now to FIGS. 3 and 4, the lid 104 is shown in isolation. FIG. 3 shows an upper perspective view of the lid 104 and FIG. 4 shows a lower perspective view of the lid 104.

The lid 104 is configured to be received in the upper opening 112 of the receptacle 102 to seal the container volume 109. Therefore, the lid 104 has a substantially rectangular shape in plan, conforming to the upper opening 112 of the receptacle. Of course, in other examples in which the receptacle has a different shape, the lid will likewise have a different shape suited to the particular receptacle.

The lid 104 is, in this example, formed from a transparent material, such as transparent plastic or toughened glass. The lid 104 is generally planar in shape and has a sealing element 106 arranged at its periphery for sealing against the peripheral wall 110 of the receptacle. To seal the container, the lid 104 is placed into the upper opening 112 of the receptacle 102 and a downward force is applied to deform the sealing element 106 against the receptacle's peripheral wall 110 and secure the lid 104 on the receptacle 102. If clips or other connectors are provided for securing the lid to the receptacle, these can be connected too.

The lid 104 comprises a pressure release valve (PRV) 116 configured to permit gases to escape from the container volume 109 and inhibit gases from entering the container volume 109 when the container 100 is sealed (i.e., when the lid 104 is attached to the receptacle 102). The pressure release valve may also be referred to as a pressure release valve. The PRV is configured to open to release gases from the container volume when the container volume reaches a predetermined threshold, for example around 2 kPa over the ambient pressure.

The PRV 116 in this example is an umbrella valve, but it should be understood that other one-way PRV types could be utilised within the keeping of this disclosure, such as duckbill valves or the like.

Providing the PRV 116 on the lid 104 provides various advantages. For example, the lid 104 is positioned uppermost in use, so dough in the container 100 is very unlikely to rise sufficiently to block the valve. Further, the receptacle, which typically becomes most contaminated with dough can be washed thoroughly without fear of damaging a delicate valve. Yet further, the valve is better positioned for relieving gas from the entire surface of the proofing dough, or evenly from a plurality of dough portions located in the receptacle.

The dough proofing container further comprises a thermometer 118 configured to measure and display a temperature of the container 100. In this example, the thermometer 118 is located on the lid 104, and in particular on an underside (i.e., a receptacle-facing side) of the lid 104 such that it is positioned within the container volume 109 when the container 100 is sealed. In this way, the thermometer 118 measures the internal temperature of the container 100.

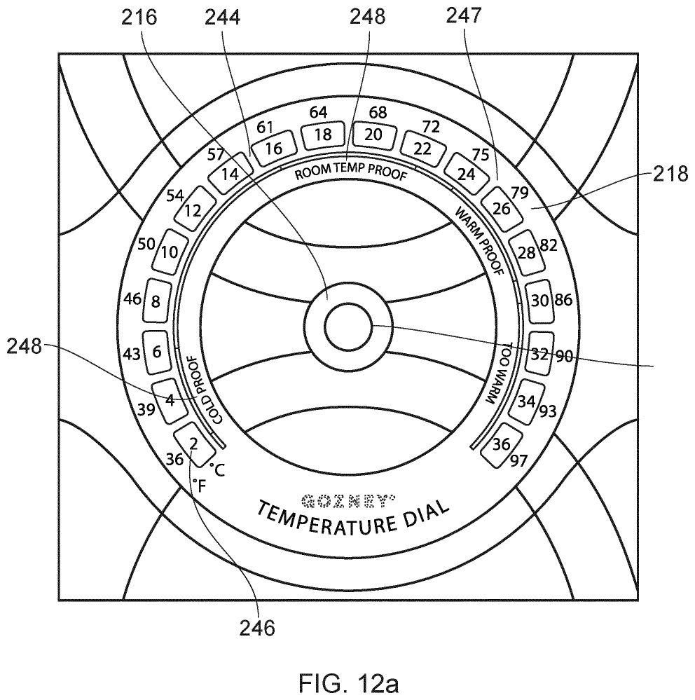

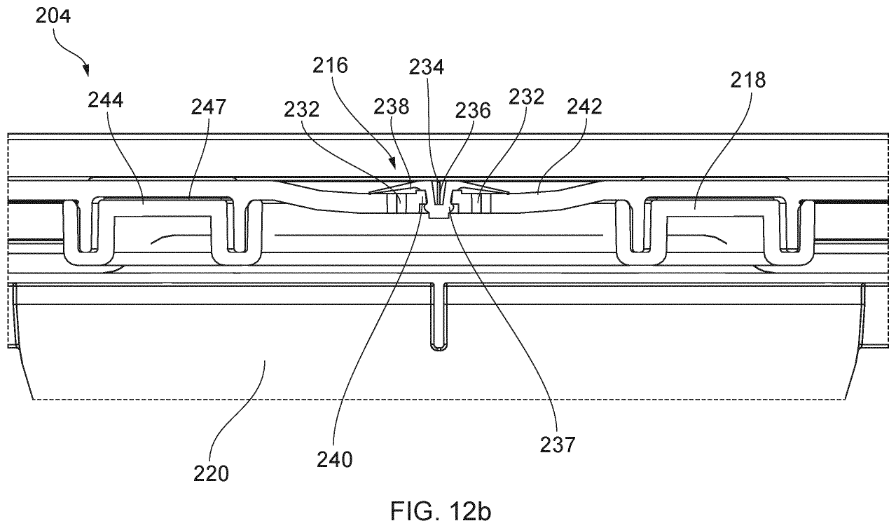

An exemplary pressure release valve and an exemplary thermometer are described in more detail with reference to FIGS. 12a and 12b below.

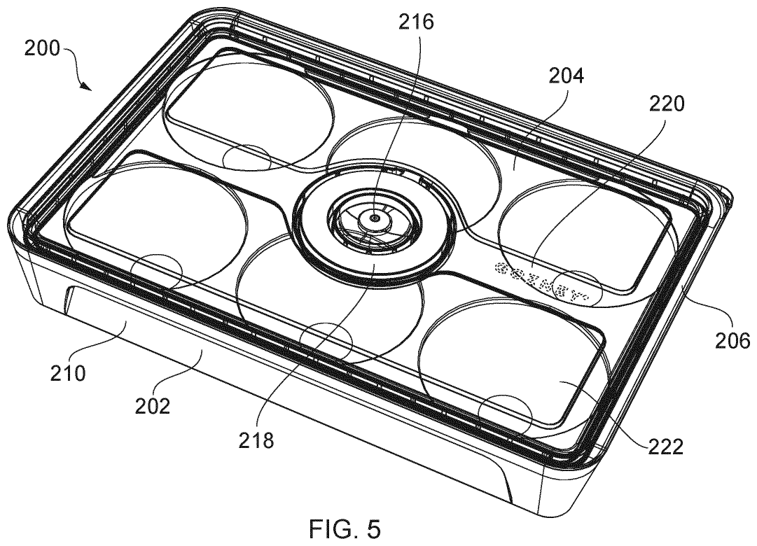

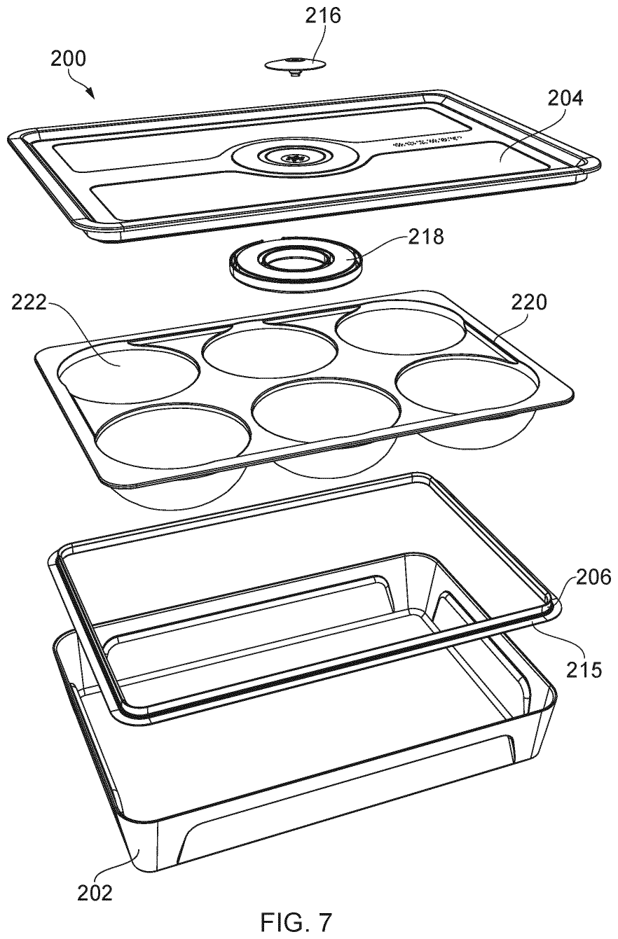

Turning now to FIGS. 5, 6, and 7, a second exemplary dough proofing container 200 is shown. Features of the container 200 which are comparable to features of the dough proofing container 100 of FIG. 1 are denoted with reference numbers differing by 100; for example, the container 100 has a receptacle 102 and a lid 104 while the container 200 has a receptacle 202 and a lid 204. Duplicated features of this type will not be described again with reference to container 200 for brevity, but it should be understood that the features of the container 100 described above likewise apply to container 200.

The dough proofing container 200 further comprises a removable dough-supporting insert 220 configured to be received in the receptacle 202. The dough-supporting insert 220 defines a relief 222 for supporting a portion of dough, and in particular a plurality of reliefs 222, each for supporting a separate portion of dough. It should be understood that a dough-supporting insert can take many forms, for example, it may be configured as an open vessel or tray with a single relief, for example having a relief bounded by a peripheral wall of the insert. The relief (or reliefs if plural) may be substantially cuboidal, ovoid, or hemispherical, or any other dough-suitable shape.

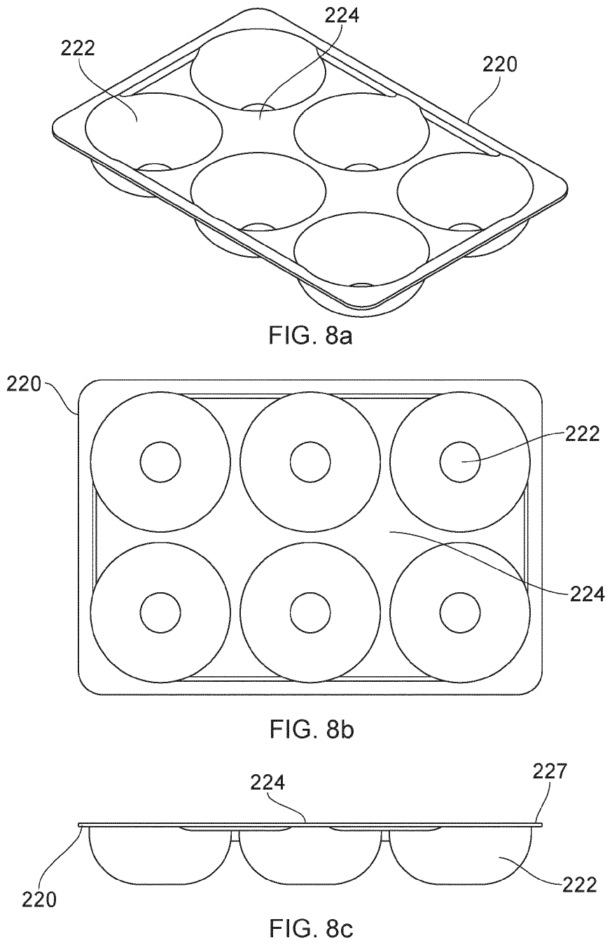

The dough-supporting insert 220 is shown in isolation in FIGS. 8a, 8b and 8c, in perspective, side and plan views respectively. The dough-supporting insert 220 comprises a substantially planar layer 224 into which six reliefs 222 are formed in two rows of three. Each relief 222 is approximately hemispherical in shape. This exemplary dough-supporting insert is a pizza dough-supporting insert, and each relief is sized to receive and support a pizza dough portion (dough ball) during proofing.

The dough-supporting insert 220 is shaped to fit within the receptacle 202. When inserted into the receptacle 202, the base of each of the reliefs 222 is in contact with the bottom surface 208 of the receptacle to support the insert, and a peripheral edge 227 of the dough-supporting insert 220 abuts the peripheral wall 210 of the receptacle such that the insert 220 is positioned securely within the receptacle and may not move laterally.

The insert 220 is configured such that an insulating airgap 225 is formed underneath the insert 220—that is between the insert 220 and the receptacle 202—which may help to insulate the dough in the reliefs 222 from temperature fluctuations outside the container 200.

The insert 220 is configured such that its total height is less than the height of the peripheral wall 210 of the receptacle 202. Therefore, when the insert 220 is placed in the receptacle 202 and the lid 204 attached, an airgap 226 is provided between the insert 220 and the lid 204, such that the reliefs 222 are all freely in communication with the PRV 216, and also provides an insulating gap between proofing dough and the lid.

The dough-supporting insert 220 is formed from a flexible material, such as silicone rubber, for case of insertion into and removal from the receptacle 202, and for case of cleaning. The dough supporting insert 220 is substantially impermeable.

The dough supporting insert 220 is an example of a single insert which can support multiple portions of dough in a plurality of reliefs, specifically for proofing pizza dough balls. Other types of inserts for other types and shapes of dough can be provided in keeping with this disclosure. For example, a single insert may comprise two, three, four, five, six, eight, or ten reliefs. The plurality reliefs may be substantially equally spaced apart or distributed across the insert. The insert may have or define a plurality of identically shaped reliefs. It should be understood that the reliefs may be configured to each receive an individual portion of dough and to separate the dough portion from other dough portions within the receptacle. Another type of insert could, for example, define one or more upstanding walls in a grid-like construction which are open at the bottom, such that dough received in the relief is in contact with the bottom surface of the receptacle, but separated from adjacent dough portions by the upstanding wall or walls of the grid.

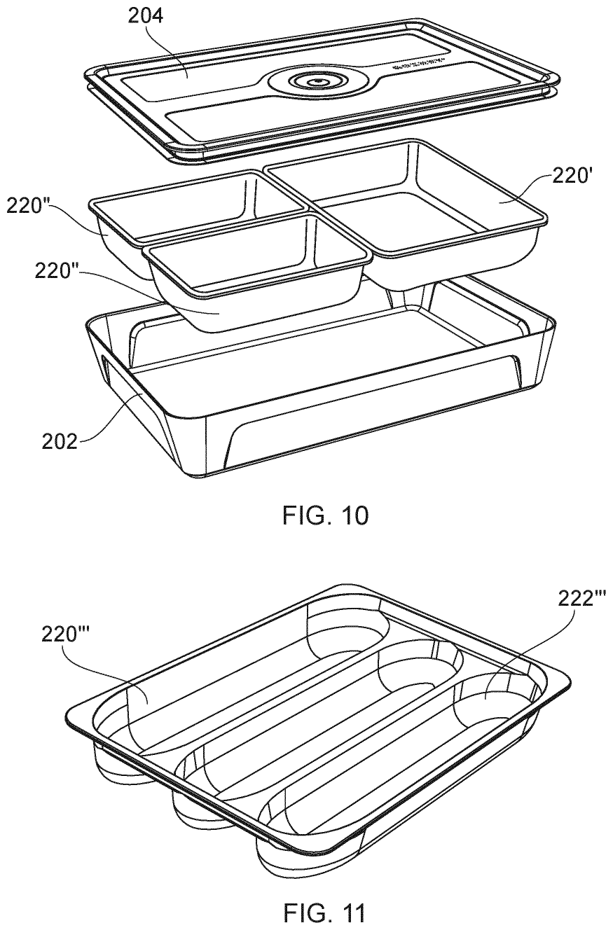

Some other exemplary insert types are described in relation to FIGS. 10 and 11 below.

As shown in FIG. 8, the sealing structure of the container 200 is shown in cross section. The lid 204 comprises a removable sealing element 206 which extends around the periphery of the lid 204. The sealing element 206 comprises a sealing lip 215 which extends laterally from the lid 204 to contact the wall 210 of the receptacle 202 and provide sealing contact between the lid and the receptacle when they are connected. In this example, the insert 220 also may comprises a supplementary peripheral sealing element 228 which is formed about the periphery of the insert 220. The supplementary sealing element 228 comprises a further sealing lip 230 which extends laterally from the insert 220 and contacts the wall 210 of the receptacle 202. When the lid 204 is connected to the receptacle 202, the supplementary sealing element 228 of the insert 220 is located between the lid and the receptacle and is compressed by the lid 204 against the receptacle wall 210 so as to form an additional sealing between the lid and the receptacle. Further, the supplementary sealing element 228 forms a seal between the airgap 226 above the insert and the airgap 225 below the insert. Therefore, the volume of air within the container in communication with the dough is minimised, which may reduce drying of the dough during proofing.

Further exemplary dough supporting inserts are shown in FIGS. 10 and 11.

As shown in FIG. 10, the dough proofing container may comprise a plurality of dough-supporting inserts 220′. The dough supporting inserts 220′ substantially tesselate within the receptacle. For example, a plurality of inserts, of the same or different types, may be installed within the receptacle to proof a plurality of separate dough portions, optionally of different types of dough or differently shaped dough portions.

In the example of FIG. 10, the receptacle 202 is substantially rectangular in plan. Three dough supporting inserts 220′, 220″ are provided. Each of the inserts 220′ and 220″ is also substantially rectangular in plan. In this example, each insert 220′, 220″ has a single relief, formed within upstanding peripheral walls of the insert, but it should be understood that one or more of the inserts may alternatively have a plurality of reliefs.

A first type of the inserts 220′ has a base surface area substantially equal to half of the base surface area of the receptacle 202. In particular, the longest side of the insert 220′ is substantially equal to the shortest side of the receptacle 202, while the shortest side of the insert 220′ is substantially equal to half of the longest side of the receptacle 202. In this way, two inserts 220′ can be placed in the receptacle so as to proof two separate dough portions.

A second type of the inserts 220″ has a base surface area substantially equal to a quarter of the base surface area of the receptacle 202. In particular, the longest side of the insert 220′ is substantially equal to half the longest side of the receptacle 202, while the shortest side of the insert 220′ is substantially equal to half of the shortest side of the receptacle 202. In this way, four inserts 220′ can be placed in the receptacle so as to proof two separate dough portions. It should be understood that two inserts 220″ take up substantially identical space within the receptacle as one insert 220′, such that the inserts 220′, 220″ can be used in a modular way within the receptacle 202. Such a configuration is shown in FIG. 10, where a single insert 220′ and two inserts 220″ are provided in the receptacle for proofing one large and two smaller dough portions in the same container.

The inserts 220′, 220″ in FIG. 10 are merely examples of modular inserts which may be utilised within the principles of this disclosure. It should be understood that a multitude of different inserts can be envisaged for complimentary use in the receptacle 202 to provide different proofing configurations for different situations. Inserts may be provided having a base surface area substantially equal to one half, one third, one quarter, one fifth, one sixth, one eighth or one tenth of a base surface area of the receptacle, such that a plurality of inserts may be located within the receptacle to substantially cover the entire base surface area of the receptacle.

FIG. 11 shows a further alternative insert 220′″. This insert comprises a plurality of reliefs 222′″, each for supporting a separate portion of dough. In this example, each of the reliefs 222′″ is elongate, for proofing baton-shaped dough portions. Four reliefs 222′″ are provided, each having a longest axis substantially parallel to the longest side of the receptacle 202 when the insert 220′″ is received therein.

Turning now to FIGS. 12a and 12b, a pressure release valve (PRV) 216 and a thermometer 218 of the container 200 are shown in more detail. FIG. 12a is a detailed plan view of the PRV 216 and thermometer 218, and FIG. 12b is a detailed cross-sectional view of the container 200 along the line S-S shown in FIG. 12a.

The PRV 216 is, in this example, configured as an umbrella valve. The PRV 216 comprises a plurality of aspiration apertures 232 formed through the lid 204 which are covered by an umbrella valve element 234. The umbrella valve element 234 comprises a central shaft portion 236 having an umbrella sealing flange 238 at a first end of the shaft portion 236. The umbrella sealing flange 238 extends radially and partially axially towards the opposing end of the shaft portion 236. The lid surface itself forms the valve seat for the umbrella valve element 234. Because the umbrella sealing flange 234 naturally extends axially, when mounted to the lid 204, the flange flattens out against the valve seat (i.e. the lid surface) such that a positive sealing force is created which holds the valve closed and tolerates minor irregularities on the lid surface which forms the valve seat.

The shaft portion 236 of the umbrella valve element 234 is removably received in a corresponding opening 240 through the lid 204 (removably retained by a circumferential detent 237), such that the umbrella sealing flange 238 seals against the surface of the lid 204. The aspiration apertures 232 are covered by the umbrella sealing flange 238, which contacts the lid to form a circular seal which encircles all of the apertures 232. The aspiration apertures 232 provide fluid communication between the container volume and the underside of the umbrella sealing flange 238. When the pressure gradient across the PRV16 exceeds a predetermined release pressure, the umbrella sealing flange 238 is lifted by the internal pressure of the container to release gas from within the container and thereby lower the container pressure. The umbrella valve element 234 is configured such that excess pressure outside the container 200 forces the umbrella sealing flange 238 against the surface of the lid 204, preventing flow of gas into the container 200 via the PRV 216. Therefore, it should be understood that the PRV 216 is a one-way valve. By way of example, the umbrella valve element 234 may allow gas flow out of the container once the head pressure reaches around 2 kPa and prevent back flow immediately in the opposite direction into the container.

The umbrella valve element 234 is removable to facilitate thorough cleaning. In other examples, pressure release valve may take a different form, such as a duckbill valve or other one-way valve.

In this example, the lid 204 comprises a valve recess 242 within which the PRV 216 is located. The valve recess 242 is a depressed area of the lid's upper surface, such that the PRV 216 is located below the lid's upper surface. This configuration may protect the PRV from damage by any objects placed on the lid 204 and may also avoid the PRV 216 from being rendered inoperable by any object placed on the lid 204, e.g., due to pressing down on the umbrella sealing flange 238.

Turning now to the thermometer 218, in this example, the thermometer 218 is formed as a thermometer ring 244 comprising thermochromic material. The thermometer ring 244 comprises a plurality of thermochromic indicators 246 forming a readable display 247. Each indicator 246 changes colour at a different temperature to indicate the temperature of the container in a clear, visual manner. In this example, the thermochromic indicators 246 indicate temperatures over a total range of 34 degrees Celsius, in 2 degree increments. Equivalent Fahrenheit readings are also shown. In particular, the thermometer scale ranges from 2 degrees Celsius to 36 degrees Celsius. In addition, the thermometer 218 comprises visual indicators 248 which indicate the appropriate temperature ranges for different proofing conditions. Arranging the thermochromic indicators 246 in a ring reduces the overall size of the thermometer, thereby providing a larger uninterrupted area for viewing the container contents through the lid 204.

The resealable lid 204 is constructed from a substantially transparent material. As is evident in FIG. 12a, the readable display 247 of the thermometer 218 is positioned so as to be visible though the resealable lid 204. The thermometer 218 is positioned on the inner surface of the lid 204, with the readable display 247 facing the lid 204. In this particular example, the thermometer 218 is connected to a receptacle-facing side/inner surface of the lid 204 in a removable manner to facilitate cleaning. Therefore, the thermometer 218 is positioned within the container volume when the lid 204 is connected to the receptacle 202. The container construction disclosed herein enables straightforward observation of the dough and measurement of the internal container temperature without opening the container volume or without removal of the lid from the receptacle.

It should be understood that, although a thermochromic thermometer is used in this example, other thermometer types may be used within the principles of this disclosure. For example, an electric, liquid-in-glass, or infrared thermometer could be configured to provide a readable display surface visible through a transparent portion of the lid, such that the internal temperature of the container volume is readable through the lid without removal.

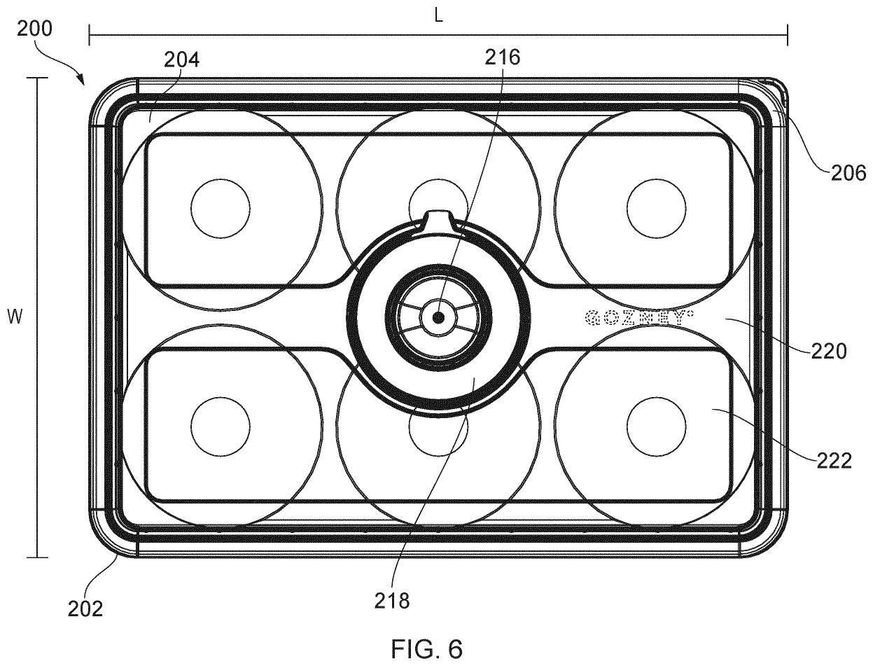

Referring also to FIGS. 5 and 6, the PRV 216 and the thermometer 218 are positioned substantially centrally on the lid 204. Furthermore, the PRV is located within the thermometer ring 244, such that the PRV 216 and thermometer 218 do not cover substantially more observable area of the lid 204 than the thermometer 218 alone. Positioning the PRV and thermometer centrally may provide advantages such as improved degassing for large or plural dough portions, providing more area across the lid to observe the contents of the container, and reducing the likelihood of the thermometer reading an isolated ‘hotspot’ within the container.

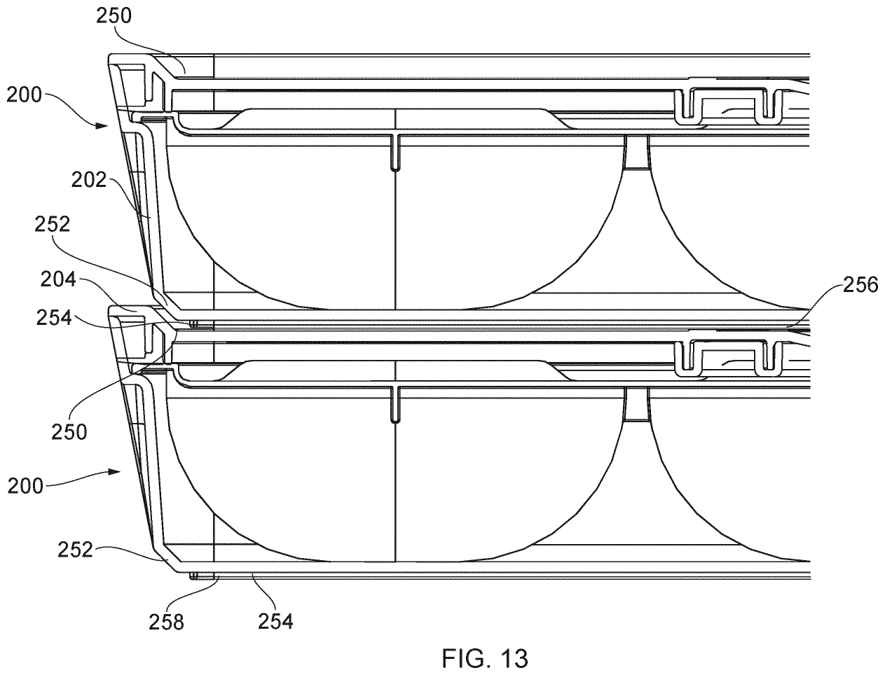

Referring to FIG. 13, two containers 200 are shown in a stacked configuration. The containers 200 comprise a number of features which better facilitate stacking for convenient storage. With reference also to FIGS. 5 and 6, the upper surface of the lid 204 comprises a stacking feature, in particular a stacking recess 250, which is shaped to conform to an external shape of the base of the receptacle 202. In this example, the stacking recess 250 and the outer base 252 of the receptacle are both chamfered such that the chamfered base 252 of a receptacle 202 is located within the chamfered stacking recess 250 of a lid. This ensures neat, orderly stacking of containers 200.

To further enhance the performance of the container 200, a spacing feature 254 is provided to space apart stacked container 200 to provide an aspirating airgap 256 between the lid 204 of a first container 200 and the receptacle 202 of another dough proofing container 200 stacked upon the first. The aspirating airgap 256 provided by the spacing feature 254 permits communication of the PRV and the ambient environment.

In this example, the spacing feature 254 is comprised of a plurality of protruding elements 258 provided on the base 252 of the receptacle 202, on an underside thereof. The protruding elements 258 contact the lid 204 of another container 200 on which the container 200 is stacked to support the container 200 slightly above the surface of the other container's lid 204. Consequently, an aspirating airgap 256 is formed between the stacked containers. Other spacing features can be envisaged, for example, the spacing feature may alternatively or additionally comprise a recess formed in the lid and/or receptacle base to provide an aspirating airgap. The aspirating airgaps provided by the spacing features may also encourage airflow around the containers, which may assist in avoiding overheating of those containers located in the middle of a container stack.

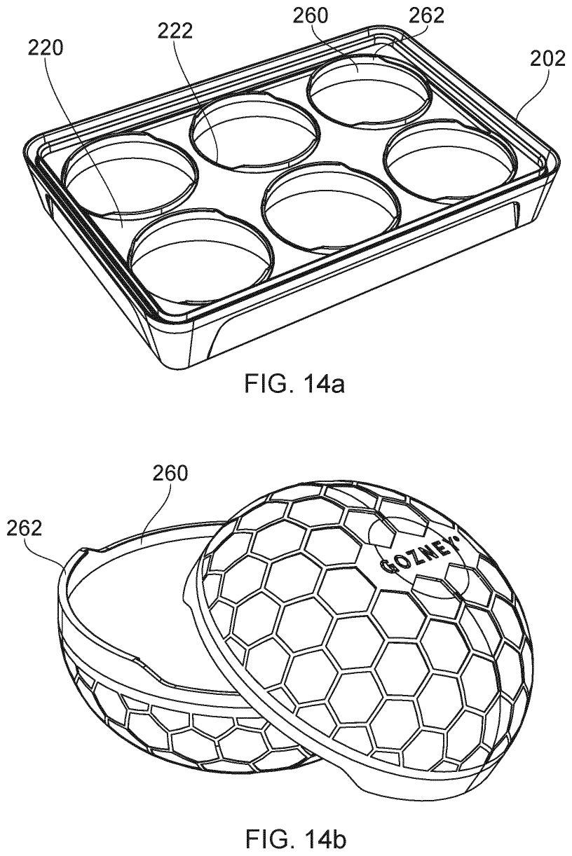

Having regard to FIGS. 14a and 14 b, a further optional feature of the container 200 is shown. The dough proofing container 200 may further comprise one or more removable liners 260 for supporting high hydration dough in the relief 222 of an insert 220. Referring to FIG. 14b, the liner 260 is a dish-like element, which has an external shape which conforms to the internal shape of the reliefs 222 of the insert 220. As shown in FIG. 14a, a liner 260 can be received in a relief 222 to line the relief 222. Providing the liners 260 enables a single dough portion in one of the reliefs 222 to be removed or handled without disturbing the insert 220 or the other dough portions. The liner or liners 260 are particularly useful for high hydration doughs, which may be damaged by rough handling.

The liners 260 are formed of a flexible material and, in this example, from silicone. The liner 260 has a different colour and texture to the insert 220 so that it can be quickly determined whether any particular relief 222 has a liner 260 by sight or touch. Furthermore, to facilitate easy removal and handling of the dough portions, each removable liner 260 comprises two gripping portions 262 which extend from an upper perimeter of the liner and, in use, protrudes above the dough-supporting insert when the liner 260 is received in a relief 222. The gripping portions 262 can be grasped to easily lift a liner 260 out of a relief 222. It should be understood that liners may be particularly useful when combined with dough-supporting inserts which have a plurality of reliefs, such as the insert 220 and the insert 220′″ so as to permit handling and transfer of one dough portion without disturbing the other dough portions in the insert.

All food contact materials (FCM) forming the container will be compliant with the relevant food contact material regulations in the respective region. All materials will be rated ‘Bisphenol-A free (BPA)’. Some exemplary materials for the various parts of the container are listed below:
Umbrella Valve Element=VMQ (Silicone)
Receptacle=Polypropylene, 20-30% glass fibres or talc reinforced
Inserts=Silicone
Thermometer=High-density polyethylene and thermochromic material
Tray Lid=Styrene-acrylonitrile resin
Tray Seal=Silicone

1. A dough proofing container comprising:
a receptacle defining a container volume;
a resealable lid, the lid being repeatably connectable to the receptacle to close the container volume, the lid comprising a pressure release valve configured to permit gases to escape from the container volume and inhibit gases from entering the container volume; and
a thermometer configured to measure and display a temperature of the container.

2. A dough proofing container according to claim 1, further comprising a removable dough-supporting insert configured to be received in the receptacle (102, 202), the dough-supporting insert comprising a relief for supporting a portion of dough.

3. A dough proofing container according to claim 2, comprising a plurality of dough-supporting inserts that substantially tesselate within the container volume.

4. A dough proofing container according to claim 2, wherein the receptacle is substantially rectangular in plan, and optionally wherein the dough-supporting insert is substantially rectangular in plan.

5. A dough proofing container according to claim 2, wherein the dough-supporting insert comprises a plurality of reliefs, each relief for supporting a separate portion of dough.

6. A dough supporting container according to claim 2, wherein the dough-supporting insert has a depth less than a depth of the receptacle so as to provide an airgap between the insert and the lid.

7. A dough proofing container as claimed in claim 5, further comprising a removable liner shaped to be received in one of the plurality of reliefs, optionally comprising a plurality of removable liners.

8. A dough proofing container as claimed in claim 6, wherein the or each removable liner comprises a gripping portion which protrudes above the dough-supporting insert when the liner is received in a relief.

9. A dough proofing container as claimed in claim 1, wherein the resealable lid is constructed from a substantially transparent material or comprises a substantially transparent portion.

10. A dough proofing container as claimed in claim 9, wherein a readable display of the thermometer is positioned so as to be visible though the resealable lid.

11. A dough proofing container as claimed in claim 1, wherein the lid comprises the thermometer.

12. A dough proofing container as claimed in claim 10, wherein the thermometer, or a portion thereof, is positioned on a receptacle-facing side of the lid so as to measure the temperature within the container volume when the lid is connected to the receptacle.

13. A dough proofing container as claimed in claim 1, wherein the thermometer comprises thermochromic material.

14. A dough proofing container as claimed in claim 1, further comprising a removable sealing element configured to form a seal between the lid and the receptacle.

15. A dough proofing container as claimed in claim 1, wherein the pressure release valve is an umbrella valve, optionally wherein a valve element of the umbrella valve is removable.

16. A dough proofing container as claimed in claim 1, wherein the pressure release valve and/or the thermometer are positioned substantially centrally on the lid.

17. A dough proofing container as claimed in claim 1, wherein the lid comprises a stacking feature shaped to conform to an external shape of a base of the receptacle.

18. A dough proofing container as claimed in claim 1, wherein the container comprises a spacing feature configured to provide an aspirating airgap between the lid and the receptacle of another dough proofing container stacked upon the lid, so as to permit communication of the pressure release valve with the ambient environment.

19. A method of using a dough proofing container according to claim 2, the method comprising:
placing a dough directly into the receptacle and connecting the lid to the receptacle;
bulk proofing the dough for a bulk proofing time;
removing the lid from the receptacle;
dividing the dough into a plurality of dough portions;
placing the insert in the receptacle;
placing a dough portion into the relief of the insert;
re-connecting the lid to the receptacle, and
proofing the dough portion for a second proofing time.
